(19) United States
(12) Patent Application Publication
(10) Pub. No.: US 2013/0038489 A1
(43) Pub. Date: Feb. 14, 2013

(54) AEROSTATIC PLATFORM FOR MONITORING AN EARTH-BASED SENSOR NETWORK

(71) Applicant: R. Stanley Williams, Portola Valley, CA (US)

(72) Inventor: R. Stanley Williams, Portola Valley, CA (US)

(21) Appl. No.: 13/643,157

(22) PCT Filed: Apr. 30, 2010
(86) PCT No.: PCT/US2010/033236

§ 371 Date: Oct. 24, 2012

(51) Int. Cl. G01S 5/02

(52) U.S. Cl. 342/450

(57) ABSTRACT

An aerostatic platform for monitoring an earth-based sensor network. The aerostatic platform includes an aerostat, at least one antenna coupled with the aerostat, and a plurality of restraints. The antenna is configurable to receive a signal transmitted from at least one sensor in the earth-based sensor network. The plurality of restraints is configurable for fixing the antenna in a fixed aerial location above the earth-based sensor network, and for maintaining the antenna in a sufficiently stationary position relative to the sensor to triangulate a location of the sensor from a locator signal received by the antenna. A sensor-network-monitoring system is also provided, along with a method for deploying the sensor-network monitoring system.

### TECHNICAL FIELD

Embodiments of the present invention relate generally to an aerostatic platform for monitoring an earth-based sensor network of a sensor-network-monitoring system, and a method for deploying the sensor-network-monitoring system.

### BACKGROUND

As the demand for resources increases with the growth of human populations, interest in developing new methodologies for the discovery and exploitation of these resources continues to grow. For example, with the emergence of increasing demand for petroleum products from rapidly developing countries, the impetus to find new reserves of oil has taken a pre-eminent role in the global economy. Moreover, increasing global populations have placed greater demands on securing the borders of countries in proximity to large populations displaced by economic stressors affecting their less fortunate neighbors. In addition, the growth of human populations along with increasing polarizations within such populations has raised the specter of terrorist assaults affecting domestic tranquility within sovereign territories. All the above, suggest applications that may profit from methodologies for monitoring large tracts of land with sensor networks.

Thus, scientists are engaged in developing new methodologies for the monitoring of diverse sensor networks deployed on the surface of the earth, whether those sensors are directed towards the discovery of new mineral resources, or towards the defense of countries from emerging threats to their security.

### DESCRIPTION OF THE DRAWINGS

The accompanying drawings, which are incorporated in and form a part of this specification, illustrate embodiments of the invention and, together with the description, serve to explain the embodiments of the invention:

FIG. 1 is a perspective view of locations for the deployment of: the earth-based sensor network, sensors in the earth-based sensor network, antennas above the earth-based sensor network, and restraints for fixing an antenna above the earth-based sensor network, in accordance with embodiments of the present invention.

FIG. 2 is a perspective view of an aerostatic platform for monitoring an earth-based sensor network, in accordance with embodiments of the present invention.

FIG. 3 is a perspective view of an alternative configuration for restraints for fixing an antenna of the aerostatic platform above the earth-based sensor network, in accordance with embodiments of the present invention.

FIG. 4 is a perspective view of a sensor-network-monitoring system showing a sensor transmitting a signal to at least one aerostatic platform of a plurality of aerostatic platforms, in accordance with embodiments of the present invention.

FIG. 5 is another perspective view of the sensor-network-monitoring system showing at least one aerostatic platform in the plurality transmitting a deployment signal to a deployer for deployment of a sensor at a location in the earth-based sensor network, in accordance with embodiments of the present invention.

FIG. 6 is a flowchart of a method for deploying a sensor-network-monitoring system, in accordance with embodiments of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the Invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present Invention. Throughout the drawings, like components are denoted by like reference numerals, and repetitive descriptions are omitted for clarity of explanation if not necessary.

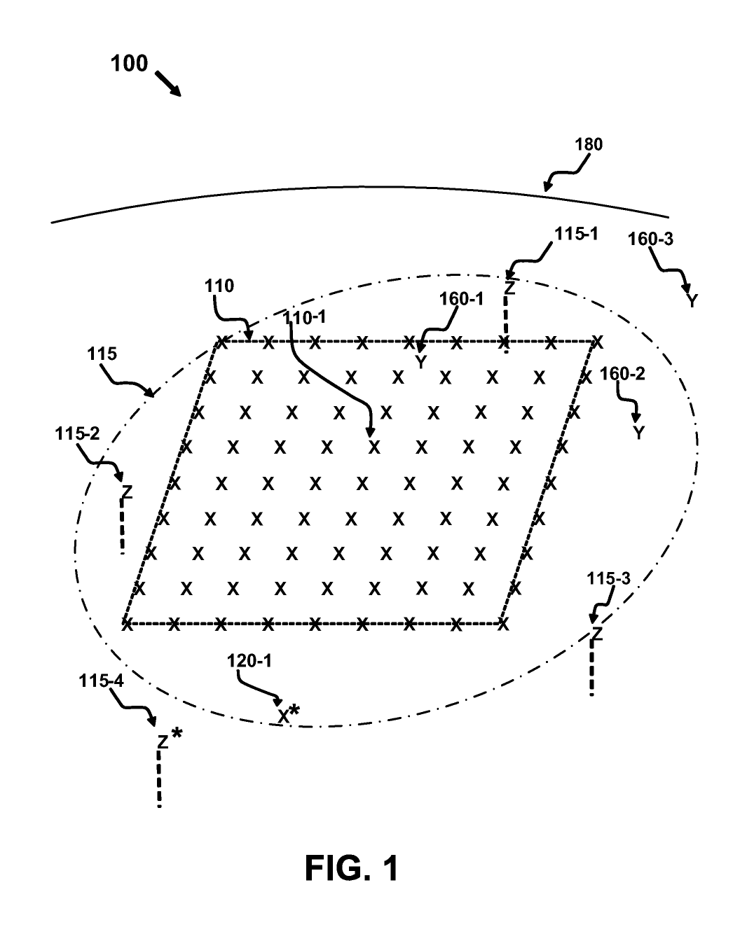

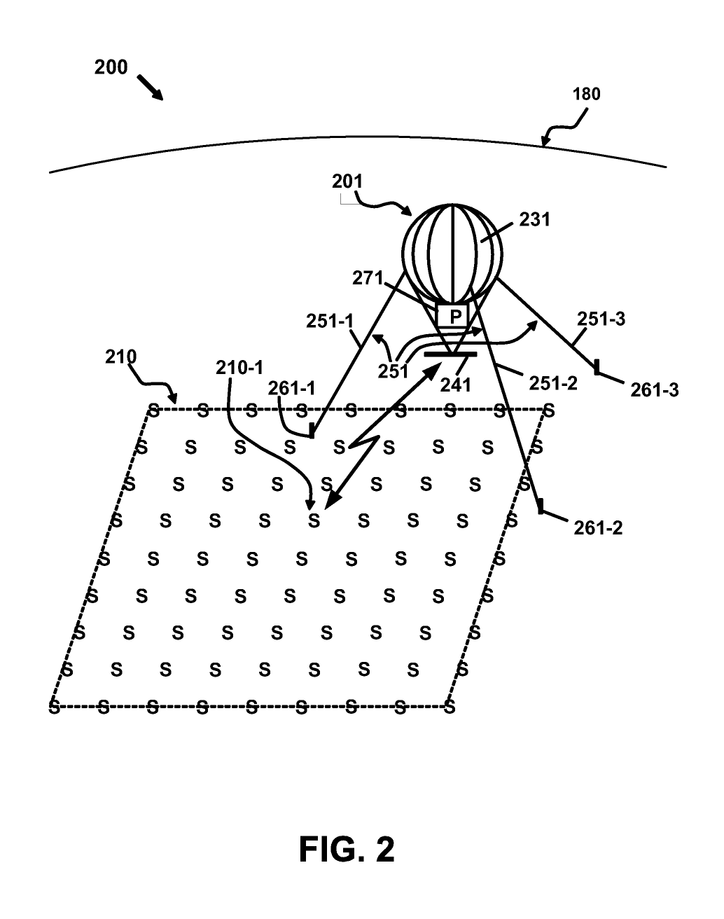

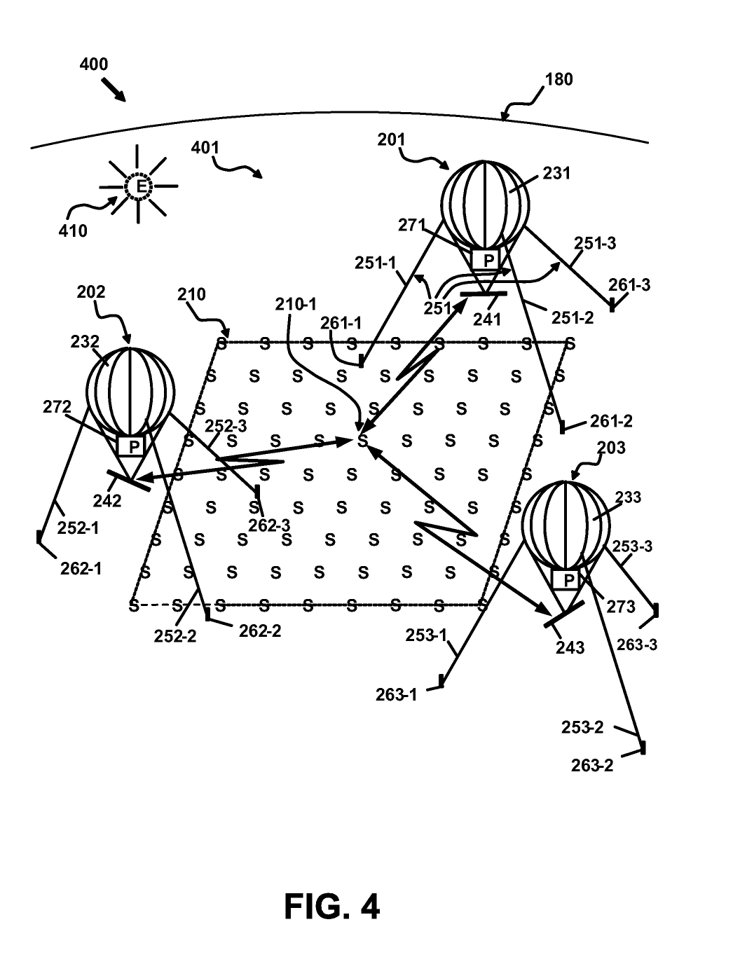

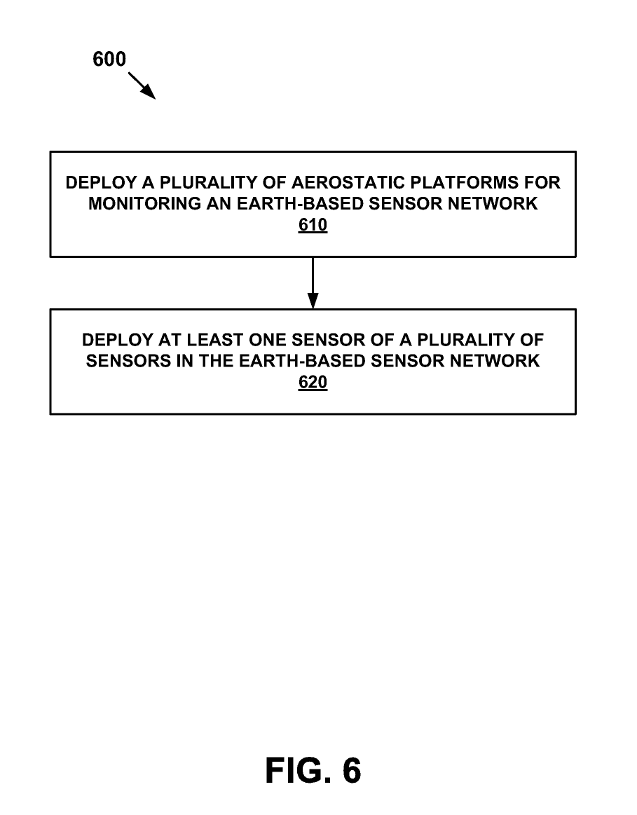

Embodiments of the present invention include an aerostatic platform 201 for monitoring an earth-based sensor network 210 (see FIGS. 1 and 2). The aerostatic platform 201 includes an aerostat 231, at least one antenna 241 coupled with the aerostat 231, and a plurality 251 of restraints 251-1, 251-2, 251-3. The antenna 241 Is configurable to receive a signal transmitted from at least one sensor 210-1 in the earth-based sensor network 210. The plurality 251 of restraints 251-1, 251-2, 251-3 is configurable for fixing the antenna 241 in an aerostatic and fixed aerial location 115-1 above the earth-based sensor network 210, and for maintaining the antenna 241 in a sufficiently stationary position relative to the sensor 210-1 in the earth-based sensor network 210 to triangulate a location 110-1 of the sensor 210-1 on a surface of the earth 180 from a locator signal received by the antenna 241 from the sensor 210-1. A sensor-network-monitoring system (401) is also provided (see FIG. 4), along with a method (see FIG. 6) for deploying the sensor-network monitoring system (401).

With reference now to FIGS. 2, 3, 4 and 5, and in particular to FIG.1, in accordance with embodiments of the present invention, a perspective view 100 is shown in FIG. 1 relevant to the subsequent description of the geometrical arrangement of various components in embodiments of the present invention, described in the discussion of FIGS. 2-5. FIG. 1 shows the surface of the earth 180, as delineated by the horizon, and locations for deployment with respect to the surface of the earth 180 of the following components, shown deployed at these locations in FIG. 2: the earth-based sensor network 210; sensors, for example, sensor 210-1, in the earth-based sensor network 210; antennas, of which antenna 241 is an example, above the earth-based sensor network 210; and restraints, for example, restraints 251-1, 251-2 and 251-3, for fixing an antenna, for example, antenna 241, above the earth-based sensor network 210. As shown in FIGS. 1 and 2, in accordance with an embodiment of the present invention, a deployment plan 110 for sensors in the earth-based sensor network 210 includes an arrangement of a plurality of locations of sensors, indicated by an “X” at each location of a sensor, for example, location 110-1 of sensor 210-1, with respect to the surface of the earth 180. By way of example, the array of sensors in the deployment plan 110 appears to be arranged in a grid pattern, without limitation thereto; but, other geometrical arrangements for the deployment of sensors within the earth-based sensor network 210 are within the spirit and scope of embodiments of the present invention. For example, even though the array of sensors in the deployment plan 110 appears to be arranged in a regular geometrical pattern, for example, the grid pattern shown in FIG. 1, a plurality of sensors arranged in an irregular array, for example, in which the sensors are randomly displaced from the locations in the grid pattern and along directions at random angular orientations relative to lines in the grid pattern, as well as displaced above and below a plane of the grid pattern, is also within the spirit and scope of embodiments of the present invention. Thus, in accordance with embodiments of the present invention, the array of sensors in the deployment plan 110 may be quite irregular, as is likely to be the case for deployments in rough terrain, which makes embodiments of the present invention that provide for locating the positions of the sensors with accuracy quite useful. For sensors arrayed in a square-grid deployment plan, similar to the deployment plan 110 shown in FIG. 1, the dimensions of the earth-based sensor network may be about 10 kilometers (km) on each side, with about one million, 1×10⁶, sensors arranged in a square-grid pattern; in such a pattern, the sensors may be spaced about every 10 meters (m) from the next adjacent sensor in two orthogonal directions. Embodiments of the present invention are directed towards a rapid means for both deployment and subsequent monitoring of sensors in the earth-based sensor network, such as, for example, earth-based sensor network 210 based on deployment plan 110. Embodiments of the present invention also provide an alternative to other techniques of sensor monitoring and deployment know in the art, such as, for example, the use of antenna towers to monitor the sensors, which involves considerable overhead in erecting a tower, and the use of trucks dragging lines of sensors onto an area of interest to deploy the sensors, which is subject to uncertainties in sensor location on rough terrains. Embodiments of the present invention also refer to an “earth-based” sensor network 210, because sensors may be deployed on various types of tracts on the surface of the earth, without limitation to terrestrial terrains.

With further reference to FIGS. 1-5 and in particular to FIGS.1 and 2, in accordance with another embodiment of the present invention, a deployment plan 115 for fixing antennas, for example, antennas 241, 242 and 243, of a plurality of at least three aerostats, for example, aerostats 231, 232, 233, includes an arrangement of a plurality of locations, for example, locations 115-1, 115-2 and 115-3, of antennas, indicated by a “Z” at each location of an antenna above the surface of the earth 180. Moreover, in accordance with a further embodiment of the present invention, a plurality of at least three non-collinear points, for example, non-collinear points 160-1, 160-2, 160-3, is provided for tethering each aerostat, of which aerostat 231 is an example, with at least three restraints 251-1, 251-2, 251-3, respectively, with an earth-fixed end of a restraint, for example, restraint 251-1, attached to the earth 180 at one point, for example, point 160-1, indicated by a “Y” at each location of an earth-fixed end of a restraint affixed to the surface of the earth 180; no two earth-fixed ends of the restraints are affixed at the same point, for example, point 160-1, without limitation thereto. Also shown in FIG. 1, in accordance with an embodiment of the present invention, another aerostatic and fixed aerial location, for example, location 115-4, associated with redeployment of the aerostatic platform, for example, aerostatic platform 201, for monitoring the earth-based sensor network 210 is provided, indicated by a “Z*” at a redeployment location of an antenna, for example, antenna 241, above the surface of the earth 180. Similarly, in another embodiment of the present invention, a location for redeployment of sensor 210-1 with respect to the surface of the earth 180, for example, location 120-1, is indicated by a “X*” in FIG. 1.

With reference now to FIG. 2 and further reference to FIG. 1, in accordance with embodiments of the present invention, a perspective view 200 is shown of an aerostatic platform 201 for monitoring an earth-based sensor network 210. In accordance with embodiments of the present invention, the aerostatic platform 201 for monitoring an earth-based sensor network 210 includes the aerostat 231, at least one antenna 241 coupled with the aerostat 231, and the plurality 251 of restraints. By way of example, the aerostatic platform 201 is shown in FIG. 2 as including a single antenna 241; however, more than the single antenna 241 shown may be suspended from the aerostat 231, as an aerostatic platform 201 including a plurality of antennas is also within the spirit and scope of embodiments of the present invention. Whether a single antenna 241, or a plurality of antennas is coupled with the aerostat 231, such antenna 241, or antennas, may be secured to the aerostat with means for maintaining the antenna 241, or antennas, in a sufficiently stationary position relative to the sensor 210-1 in the earth-based sensor network 210 to triangulate the location 110-1 of the sensor 210-1 on the surface of the earth 180; such means may include cables and lines, without limitation thereto, configurable to rigidly couple the antenna 241, or antennas, to the aerostat. In one embodiment of the present invention, the aerostat 231 may include a balloon, without limitation thereto, as other aerostats such as blimps, air-ships, and other lighter-than-air and buoyant aircraft are also within the spirit and scope of embodiments of the present invention. The antenna 241 is configurable to receive a signal transmitted from at least one sensor 210-1 in the earth-based sensor network 210. As shown in FIG. 2, by way of example, the earth-based sensor network 210 includes a plurality of sensors, as indicated by the letter “S”, which are located at the plurality of locations of sensors, indicated by an “X” in FIG. 1, without limitation thereto. The plurality 251 of restraints is configurable for fixing the antenna 241 in an aerostatic and fixed aerial location, for example, location 115-1, above the earth-based sensor network 210, and for maintaining the antenna 241 in a sufficiently stationary position relative to the sensor 210-1 in the earth-based sensor network 210 to triangulate the location 110-1 of the sensor 210-1 on the surface of the earth 180 from a locator signal (shown as a heavy double headed arrow in FIG. 2) received by the antenna 241 from the sensor 210-1.

With further reference to FIGS. 1 and 2, in accordance with embodiments of the present invention, the plurality 251 of restraints may include at least three restraints 251-1, 251-2 and 251-3 coupled with the aerostat 231 at respective ends of the restraints 251-1, 251-2 and 251-3. The other respective ends of the restraints, for example, restraints 251-1, 251-2 and 251-3, are configurable for attachment to the earth 180 at at least three non-collinear points 160-1, 160-2 and 160-3 such that no two earth fixed ends of the restraints is affixed at the same point, without limitation thereto. As shown in FIG. 2, by way of example, stakes 261-1, 261-2 and 261-3 affix the earth-bound ends of the restraints, for example, restraints 251-1, 251-2 and 251-3, to the earth at the points 160-1, 160-2, 160-3, respectively, without limitation thereto, as other means for affixing the earth-bound ends of the restraints to the earth are also within the spirit and scope of embodiments of the present invention. For example, in one embodiment of the present invention, the earth-bound ends of the restraints may be affixed to motorized utility vehicles that are heavy enough so as not to be buoyed up aloft with the aerostat, which are located in proximity to the points 160-1, 160-2, 160-3, such that the earth-bound ends of the restraints are essentially affixed at the points 160-1, 160-2 and 160-3. In accordance with embodiments of the present invention, the aerostatic platform 201 further includes a payload 271 indicated by the letter “P”; the payload 271 may be selected from the group consisting of a global-positioning-system receiver, a transmitter for sending signals from the aerostatic platform 201, a receiver for receiving signals sent to the aerostatic platform 201, and a computer for processing the signals, and combinations of the global-positioning-system receiver, the transmitter, the receiver, and the computer, without limitation thereto. In accordance with one embodiment of the present invention, if the payload 271 of the aerostatic platform 201 includes the global-positioning-system receiver, the global-positioning-system receiver may be configured to provide co-ordinates of the aerostatic and fixed aerial location 115-1 of the antenna 241.

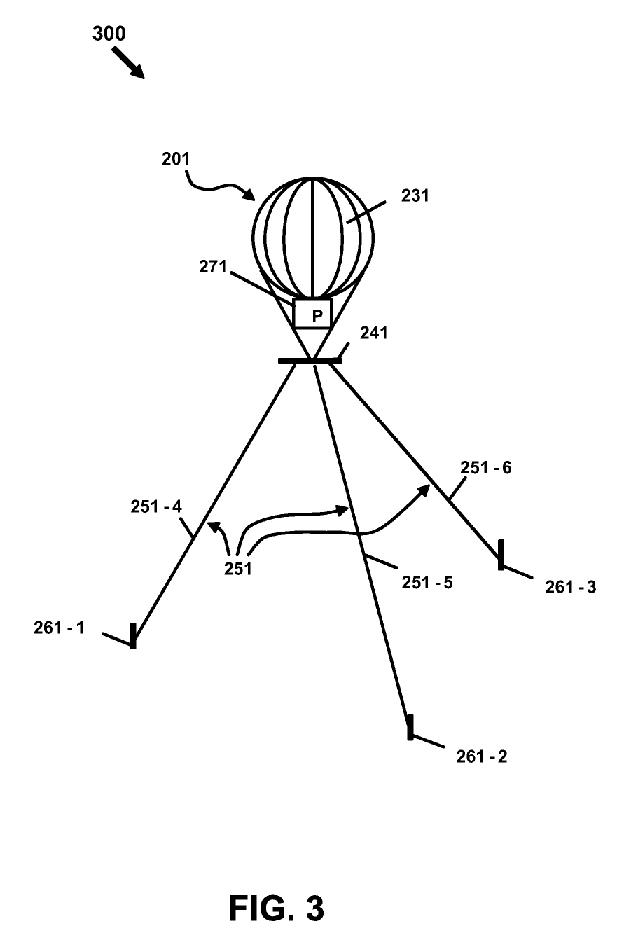

With reference now to FIG. 3, in accordance with embodiments of the present invention, a perspective view 300 is shown of an alternative configuration for a plurality 251 of restraints for fixing the antenna 241 of the aerostatic platform 201 above the earth-based sensor network 210. In accordance with another embodiment of the present invention, the plurality 251 of restraints may include at least three restraints 251-4, 251-5, 251-6 coupled with the antenna 241. Moreover, in accordance with an embodiment of the present invention, the plurality 251 of restraints may include both restraints coupled with the aerostat 231, for example, the three restraints 251-1, 251-2, 251-3, and restraints coupled with the antenna 241, for example, the three restraints 251-4, 251-5, and 251-6; in the case in which restraints are used for both the aerostat 231 and the antenna 241, a level of redundancy is provided for securing the antenna in the aerostatic and fixed aerial location. Any of the restraints 251-1 through 251-6 may be selected from the group consisting of tethering lines, guy wires, ropes, chains, or similar readily deployable and portable restraints, without limitation thereto. In accordance with an embodiment of the present invention, the aerostatic platform 201 is configured to be redeployable; and, the antenna 241 is configured to be moved to and to be set up at another aerostatic and fixed aerial location, for example, location 115-4, as shown in FIG.1. In accordance with embodiments of the present invention, the redeployability of the aerostatic platform 201 provides for ease of mobility of the antenna 241 in contrast with other antenna support structures, such as towers, or trucks with erectable towers, which may involve tedious assembly and disassembly procedures.

With reference now to FIG, 4 and further reference to FIG. 1, in accordance with embodiments of the present invention, a perspective view 400 is shown of a sensor-network-monitoring system 401 showing the sensor 210-1 transmitting a signal to at least one aerostatic platform 201 of a plurality of aerostatic platforms 201, 202 and 203. In accordance with embodiments of the present invention, the sensor-network-monitoring system 401 includes a plurality of aerostatic platforms 201, 202 and 203, by way of example without limitation thereto, for monitoring an earth-based sensor network 210. In accordance with embodiments of the present invention, each aerostatic platform, for example, one of aerostatic platforms 201, 202 and 203, of the plurality of aerostatic platforms 201, 202 and 203 includes: a respective aerostat, for example, one of aerostats 231, 232 and 233; at least one antenna, for example, one of respective antennas 241, 242 and 243, and, a respective plurality of restraints, for example: restraints 251-1, 251-2 and 251-3; restraints 252-1, 252-2 and 252-3; and, restraints 253-1, 253-2 and 253-3, respectively. In accordance with embodiments of the present invention, each respective antenna, for example, one of respective antennas 241, 242 and 243, is coupled with a respective aerostat, for example, one of aerostats 231, 232 and 233. In addition, in accordance with embodiments of the present invention, each respective plurality of restraints, for example, plurality 251 of restraints 251-1, 251-2 and 251-3, plurality of restraints 252-1, 252-2 and 252-3, and, plurality of restraints 253-1, 253-2 and 253-3, is configured for fixing a respective antenna, for example, one of respective antennas 241, 242 and 243, in a respective aerostatic and fixed aerial location, for example, one of respective locations 115-1, 115-2 and 115-3, above the earth-based sensor network 210; each respective plurality of restraints is also configured for maintaining the respective antenna, for example, one of respective antennas 241, 242 and 243, in a sufficiently stationary position relative to the sensor 210-1 in the earth-based sensor network 210 to triangulate the location 110-1 of the sensor 210-1 on the surface of the earth 180 from a locator signal (shown as respective heavy double headed arrows in FIG. 4) received by the respective antennas 241, 242 and 243, from the sensor 210-1.

With further reference now to FIGS. 4 and 1, in accordance with embodiments of the present invention, to restrain the antennas 241, 242 and 243, pluralities of at least three respective restraints, for example, plurality 251 of restraints 251-1, 251-2 and 251-3, plurality of restraints 252-1, 252-2 and 252-3, and, plurality of restraints 253-1, 253-2 and 253-3, are coupled with the respective aerostats 231, 232 and 233 at respective pluralities of ends of the restraints. The other respective ends of the restraints, for example, restraints 251-1, 251-2 and 251-3, restraints 252-1, 252-2 and 252-3, and, restraints 253-1, 253-2 and 253-3, respectively, are configured for attachment to the earth 180 at three pluralities of three non-collinear points, such that no two earth-fixed ends of the restraints is affixed at the same point. As shown in FIG. 4, by way of example, stakes 261-1, 261-2 and 261-3 affix the earth-bound ends of the plurality 251 of restraints 251-1, 251-2 and 251-3 to the earth at the respective non-collinear points 160-1, 160-2, and 160-3. Similarly, stakes 262-1, 262-2 and 262-3 affix the earth-bound ends of the restraints 253-1, 253-2 and 253-3 to the earth at respective non-collinear points; and, stakes 263-1, 263-2 and 263-3 affix the earth-bound ends of the restraints 253-1, 253-2 and 253-3 to the earth at respective non-collinear points, without limitation thereto, as other means for affixing the earth-bound ends of the restraints to the earth are also within the spirit and scope of embodiments of the present invention, as previously described.

With further reference now to FIGS. 4 and 1, in accordance with embodiments of the present invention, each of the aerostatic platforms 201, 202 and 203 further includes a respective payload 271, 272 and 273 indicated by the letter “P”; each of the payloads 271, 272 and 273 may be selected from the group consisting of: a global-positioning-system receiver; a transmitter for sending signals from an aerostatic platform, for example, one of aerostatic platforms 201, 202 and 203; a receiver for receiving signals sent to the aerostatic platform, for example, one of aerostatic platforms 201, 202 and 203; a computer for processing the signals; and, combinations of the global-positioning-system receiver, the transmitter, the receiver, and the computer, without limitation thereto. In accordance with one embodiment of the present invention, if the payloads 271, 272 and 273 of the respective aerostatic platforms 201, 202 and 203 include global-positioning-system receivers, the global-positioning-system receivers are configured to provide co-ordinates of the respective aerostatic and fixed aerial locations 115-1, 115-2 and 115-3 of the respective antennas 241, 242 and 243. By way of example, in accordance with embodiments of the present invention, the co-ordinates of the respective aerostatic and fixed aerial locations 115-1, 115-2 and 115-3 may be used to triangulate the location 110-1 of the sensor 210-1 on the surface of the earth 180 from the locator signal (shown as respective heavy double headed arrows in FIG. 4) received by the plurality of respective antennas 241, 242 and 243, without limitation thereto. Thus, in accordance with an embodiment of the present invention, the plurality of aerostatic platforms 201, 202 and 203 includes at least three aerostatic platforms 201, 202 and 203, such that the plurality of aerostatic platforms 201, 202 and 203 are configured to triangulate the location 110-1 of the sensor 210-1 on the surface of the earth 180 from the locator signal (shown as respective heavy double headed arrows in FIG. 4) received by the plurality of respective antennas 241, 242 and 243 of the plurality of aerostatic platforms 201, 202 and 203 from the sensor 210-1. Although the sensor-network-monitoring system 401 has been described above in terms of a plurality of aerostatic platforms 201, 202 and 203, previously described embodiments of the present invention for the aerostatic platform 201 may be incorporated within the environment of the sensor-network-monitoring system 401 for each aerostatic platform of the plurality of aerostatic platforms 201, 202 and 203, without limitation thereto.

With further reference to FIGS. 4 and 1, in accordance with one embodiment of the present invention, the sensor-network-monitoring system 401 also further includes an earth-based sensor network 210, such that the earth-based sensor network 210 includes at least one sensor 210-1 of a plurality of sensors deployed on the surface of the earth 180 with the sensor 210-1 configured to transmit a signal (for example, any one of respective heavy double headed arrows in FIG. 4) to at least one aerostatic platform of the plurality of aerostatic platforms 201, 202 and 203. In one embodiment of the present invention, the sensor-network-monitoring system 401 provides a central nervous system for the earth (CeNSE) that can provide a variety of data from the surface of the earth 180. In one embodiment of the present invention, the plurality of aerostatic platforms 201, 202 and 203 are arranged to provide a direct line-of-sight to sensors in the earth-based sensor network 210 for reception of a signal from, or transmission of a signal to, a sensor, for example, sensor 210-1, even if the sensor-network-monitoring system 401 is deployed over rough terrain, or rugged environments, such as, hilly areas in which signal reception by an antenna of a ground-based system might be impeded, in contrast with a direct line-of-sight offered by an aerostat 201 positioned at an elevated location, for example, location 115-1. In an embodiment of the present invention, the sensor-network-monitoring system 401 is configured to provide information about the effects of an event 410 on sensors in the plurality of sensors, of which sensor 210-1 is an example, through transmission of a signal (for example, any one of respective heavy double headed arrows in FIG. 4) associated with the event 410. For example, through the effects of the event 410 on at least one sensor 210-1 in the earth-based sensor network 210, the signal may provide data about: the event 410, itself; and/or, the effects of the event 410 on the earth. Consequently, in accordance with embodiments of the present invention, the sensor 210-1 may be selected from the group consisting of an accelerometer, a geophone, a seismometer, a camera, an acoustic sensor, a motion sensor, an electronic eye, a chemical sensor, a radar installation, a temperature sensor, a humidity sensor, a barometer, an anemometer, a weather sensor, and a radiation detector, without limitation thereto. By way of example, in one embodiment of the present invention, the event 410 may be the artificially produced vibration of a seismic vibrator used to induce vibrations in the earth for reflection seismography, as is used in petroleum exploration. On the other hand, in another embodiment of the present invention, the event 410 might be of natural origin, such as, an earthquake. Thus, in accordance with embodiments of the present invention, the signal transmitted from the sensor 210-1 includes geophysical data, which may be derived from a geophone, or alternatively, a seismometer, or other geophysical sensor.

By way of further example, with further reference to FIGS. 4 and 1, in accordance with another embodiment of the present invention, the event 410 may be the crossing of a boundary by an intruder, as in a surveillance application. Thus, in accordance with embodiments of the present invention, the signal transmitted from the sensor 210-1 may include security data, which may be derived from a camera, a motion sensor, an acoustic sensor, and/or an electronic eye. For example, in one embodiment of the present invention, the event 410 may be the crossing of a border by an undocumented alien, as in a border security application. On the other hand, in accordance with another embodiment of the present invention, the event 410 may be the appearance of a deleterious substance within the field of the earth-based sensor network 210, as in a safety monitoring application. Thus, in accordance with embodiments of the present invention, the signal transmitted from the sensor 210-1 may include safety data, which may be derived from a chemical sensor, or alternatively, a radiation detector, without limitation thereto. In yet another embodiment of the present invention, the event 410 may be the appearance of an invasive entity within the field of the earth-based sensor network 210, as in a defense application. Thus, in accordance with embodiments of the present invention, the signal transmitted from the sensor 210-1 may include warning data, which may be derived from a radar installation, without limitation thereto. In another embodiment of the present invention, the event 410 may be an atmospheric occurrence, as in a weather monitoring application. Thus, in accordance with embodiments of the present invention, the signal transmitted from the sensor 210-1 may include weather data, which may be derived from a temperature sensor, a humidity sensor, a barometer, an anemometer, and/or other weather sensor, without limitation thereto. For example, in one embodiment of the present invention, the event 410 may be a change in conditions presenting in an outdoors environment, for example, in a forest, or alternatively, a field of a crop, as in forestry, conservation, or an agricultural application.

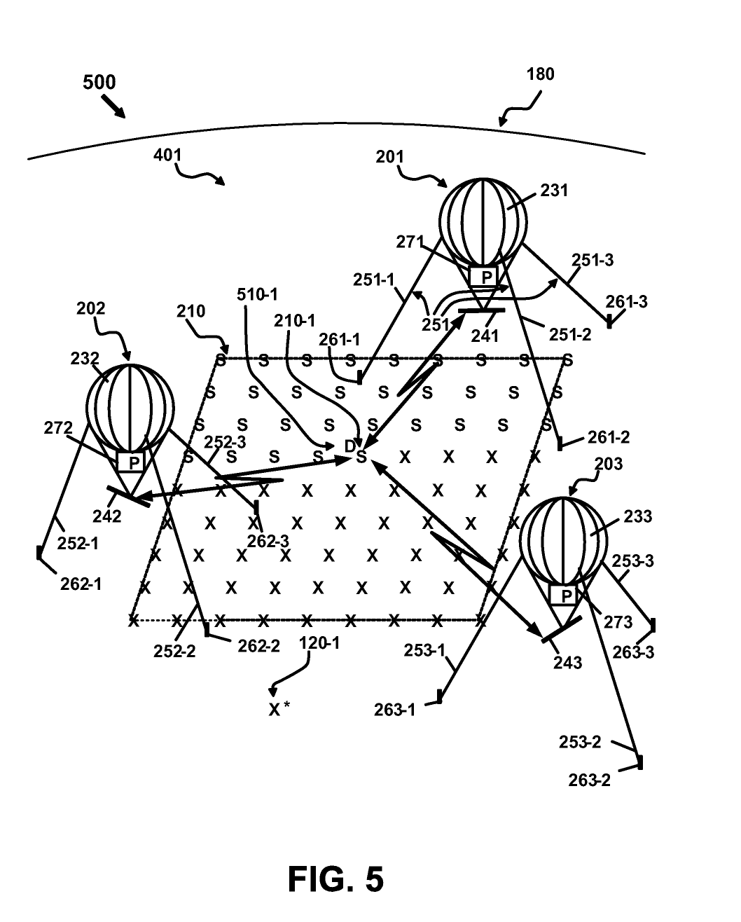

With reference now to FIG. 5 and further reference to FIGS. 1. 3 and 4, in accordance with other embodiments of the present invention, another perspective view 500 is shown of the sensor-network-monitoring system 401 in a partially deployed state. Components of the sensor-network-monitoring system 401 labeled with the same reference numerals in FIGS. 1, 2, 4 and 5 are as previously described. FIG. 5 shows at least one aerostatic platform, for example, aerostatic platform 201, in the plurality of aerostatic platforms 201, 202 and 203 transmitting to a deployer 510-1 a deployment signal (shown as the heavy double headed arrow directed from antenna 241 to the deployer 510-1 in FIG. 5) for deployment of the sensor 210-1 at the location 110-1 in the earth-based sensor network 210. In accordance with yet another embodiment of the present invention, the plurality of aerostatic platforms 201, 202 and 203 may be configured to transmit a deployment signal from at least one aerostatic platform 201 of the plurality of aerostatic platforms 201, 202 and 203 to the deployer 510-1 of at least one sensor 210-1 of the plurality of sensors of the earth-based sensor network 210 when the sensor 210-1 is positioned in close proximity to the location 110-1 on the surface of the earth 180. In accordance with embodiments of the present invention, the deployer 510-1 may be a person who deploys the sensors of the earth-based sensor network 210 in similar fashion to the manner in which a farm laborer plants seedlings, without limitation thereto, as other types of deployers are also within the spirit and scope of embodiments of the present invention. In accordance with embodiments of the present invention, sensors, of which sensor 210-1 is an example, in the earth-based sensor network 210 are readily deployable, as well as redeployable. Thus, in one embodiment of the present invention, after a region of interest on the surface of the earth has been monitored, or alternatively, surveilled, the entire earth-based sensor network 210 may be picked up and redeployed to another area of interest on the surface of the earth 180. In one embodiment of the invention envisioned by the inventor, the monitoring operation includes a continuous process for surveying large areas of the surface of the earth 180 where several sensor-network-monitoring systems, of which sensor-network-monitoring system 401 is an example, are deployed, and subsequently redeployed in an on-going operation rolling across larges tracts on the surface of the earth 180. The above described mode of operation is expected to be especially useful in mineralogical prospecting operations, such as, petroleum exploration. Thus, in one embodiment of the present invention, at least one sensor 210-1 of the plurality of sensors in the earth-based sensor network 210 is also configured to be redeployed at another location 120-1, indicated by “X*” in FIGS. 1 and 5, on the surface of the earth 180. Thus, embodiments of the present invention provide mobile communications platforms that may be deployed in rugged, remote, and/or dynamically changing environments. Details for the method of deploying a sensor, for example, sensor 210-1, in the earth-based sensor network 210 of the sensor-network-monitoring system 401, are next described.

With reference now to FIG. 6, in accordance with yet other embodiments of the present invention, a flowchart 600 is shown of a method for deploying a sensor-network-monitoring system. The method for deploying a sensor-network-monitoring system includes the following. At 610, a plurality of aerostatic platforms is deployed for monitoring an earth-based sensor network. At 620, at least one sensor of the plurality of sensors is deployed in the earth-based sensor network.

With further reference to FIGS. 1, 3, 4 and 6, in accordance with embodiments of the present invention, the deploying 610 of a plurality of aerostatic platforms, for example, aerostats 231, 232 and 233, includes the following. A plurality of at least three aerostats 231, 232 and 233 is provided in proximity to suitable locations 115-1, 115-2 and 115-3 for monitoring a plurality of sensors in the earth-based sensor network 210. An aerostat 231 of the plurality of aerostats 231, 232 and 233 is attached to a respective antenna 241. Gas envelopes of the aerostats 231, 232 and 233 are filled with a buoyant gas, such that the gas has less density than the ambient air; thus, the gas may be referred to by the term of art, “lighter-than-air,” although the gas may be selected from the group consisting of hydrogen, helium, hot air, meaning air hotter than ambient air, and other buoyant gases with respect to the ambient air. Each aerostat, of which aerostat 231 is an example, is tethered with at least three restraints 251-1, 251-2 and 251-3, respectively, with an earth-fixed end of a restraint attached to earth 180 at one point 160-1 of three non-collinear points 160-1, 160-2 and 160-3, another end of the restraint attached to the aerostat 231, and no two earth-fixed ends of the restraints affixed at the same point, without limitation thereto. Alternatively, each antenna, of which antenna 241 is an example, may be tethered with at least three restraints 251-4, 251-5 and 251-6, respectively, with an earth-fixed end of a restraint attached to earth 180 at one point 160-1 of three non-collinear points 160-1, 160-2 and 160-3, another end of the restraint attached to the antenna 241, and no two earth-fixed ends of the restraints affixed at the same point, without limitation thereto, as previously described in the discussion of FIG. 3. The antennas 241 are configured to receive a signal transmitted from at least one sensor 210-1 in the earth-based sensor network 210. The aerostats 231, 232 and 233 are raised in proximity to the locations 115-1, 115-2 and 115-3 for monitoring a plurality of sensors in the earth-based sensor network 210. The antennas 241, 242 and 243 are affixed in the aerostatic and fixed aerial locations 115-1, 115-2 and 115-3, respectively, above the earth-based sensor network 210. The antennas 241, 242 and 243 are maintained in sufficiently stationary positions relative to the sensor 210-1 in the earth-based sensor network 210 to triangulate the location 110-1 of the sensor 210-1 on the surface of the earth 180 from the locator signal received by the antennas 241, 242 and 243 from the sensor 210-1.

With further reference to FIGS. 1. 5 and 6, in accordance with embodiments of the present invention, the deploying 620 the sensor, for example, sensor 210-1, includes the following. A deployer 510-1 is provided of the sensor 210-1 with the sensor 210-1 in proximity to an area of interest on the surface of the earth 180 monitored by the earth-based sensor network 210. The locator signal is received from the sensor 210-1 at the antennas 241, 242 and 243 of the plurality of aerostatic platforms 201, 202 and 203. A location 110-1 is triangulated of the sensor 210-1 with respect to the surface of the earth 180. An offset of the location 110-1 is measured from a designated location in the deployment plan 110 for sensors in the earth-based sensor network 210, without limitation thereto. A deployment signal is transmitted from at least one aerostatic platform 201 of the plurality of aerostatic platforms 201, 202 and 203 to the deployer 510-1 of the sensor 210-1 if the offset of the location 110-1 of the sensor 210-1 from the designated location on the surface of the earth 180 is less than a designated value. The sensor 210-1 is placed at the location 110-1 in proximity to the designated location in response to the deployment signal.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It may be intended that the scope of the invention be defined by the claims appended hereto and their equivalents.

1-15. (canceled)

16. An aerostatic platform for monitoring an earth-based sensor network, said aerostatic platform comprising:
an aerostat;
at least one antenna coupled with said aerostat, said antenna configurable to receive a signal transmitted from at least one sensor in said earth-based sensor network; and
a plurality of restraints configurable for fixing said antenna in an aerostatic and fixed aerial location above said earth-based sensor network, and for maintaining said antenna in a sufficiently stationary position relative to said sensor in said earth-based sensor network to triangulate a location of said sensor on a surface of the earth from a locator signal received by said antenna from said sensor.

17. The aerostatic platform of claim 16, wherein said plurality of restraints comprises at least three restraints coupled with said aerostat.

18. The aerostatic platform of claim 16, wherein said plurality of restraints comprises at least three restraints coupled with said antenna.

19. The aerostatic platform of claim 16, further comprising a payload selected from the group consisting of a global-positioning-system receiver, a transmitter for sending signals from the aerostatic platform, a receiver for receiving signals sent to the aerostatic platform, and a computer for processing said signals, and combinations thereof.

20. The aerostatic platform of claim 19, wherein said global-positioning-system receiver is configured to provide co-ordinates of said aerostatic and fixed aerial location of said antenna.

21. The aerostatic platform of claim 16, wherein said aerostatic platform is configured to be redeployable, wherein said antenna is configured to be moved to and to be set up at another aerostatic and fixed aerial location.

22. A sensor-network-monitoring system, comprising:
a plurality of aerostatic platforms for monitoring an earth-based sensor network, an aerostatic platform of said plurality of aerostatic platforms comprising:
an aerostat;
at least one antenna coupled with said aerostat, said antenna configured to receive a signal transmitted from at least one sensor in said earth-based sensor network; and
a plurality of restraints configured for fixing said antenna in an aerostatic and fixed aerial location above said earth-based sensor network, and for maintaining said antenna in a sufficiently stationary position relative to a sensor in said earth-based sensor network to triangulate said location of said sensor on a surface of the earth from a locator signal received by said antenna from said sensor.

23. The sensor-network-monitoring system of claim 22, wherein said plurality of aerostatic platforms comprises:
at least three aerostatic platforms; and
wherein said plurality of aerostatic platforms is configured to triangulate said location of said sensor on said surface of said earth from said locator signal received by a plurality of respective antennas of said plurality of aerostatic platforms from said sensor.

24. The sensor-network-monitoring system of claim 22, further comprising:
an earth-based sensor network, said network comprising:
at least one sensor of a plurality of sensors deployed on said surface of said earth, said sensor configured to transmit a signal to at least one aerostatic platform of said plurality of aerostatic platforms.

25. The sensor-network-monitoring system of claim 24, wherein at least one sensor of said plurality of sensors in said earth-based sensor network is configured to be redeployed at another location on said surface of said earth.

26. The sensor-network-monitoring system of claim 24, wherein said plurality of aerostatic platforms are configured to transmit a deployment signal from at least one aerostatic platform of said plurality of aerostatic platforms to a deployer of at least one sensor of said plurality of sensors of said earth-based sensor network when said sensor is positioned in close proximity to said location on said surface of said earth.

27. The sensor-network-monitoring system of claim 24, wherein said signal transmitted from said sensor comprises geophysical data.

28. The sensor-network-monitoring system of claim 24, wherein said sensor is selected from the group consisting of an accelerometer, a geophone, a seismometer, a camera, an acoustic sensor, a motion sensor, an electronic eye, a chemical sensor, a radar installation, a temperature sensor, a humidity sensor, a barometer, an anemometer, a weather sensor, and a radiation detector.

29. A method for deploying a sensor-network-monitoring system, said method comprising:
deploying a plurality of aerostatic platforms for monitoring an earth-based sensor network; and
deploying at least one sensor of said plurality of sensors in said earth-based sensor network.

30. The method recited in claim 29, wherein said deploying a plurality of aerostatic platforms comprises:
providing a plurality of at least three aerostats in proximity to suitable locations for monitoring a plurality of sensors in said earth-based sensor network;
attaching to an aerostat of said plurality of aerostats a respective antenna;
filling gas envelopes of said aerostats with a buoyant gas;
tethering each aerostat with at least three restraints, respectively, with an earth-fixed end of a restraint attached to earth at one point of three non-collinear points, another end of said restraint attached to said aerostat, and no two earth-fixed ends of said restraints affixed at said same point;
configuring said antennas to receive a signal transmitted from at least one sensor in said earth-based sensor network;
raising said aerostats in proximity to said locations for monitoring a plurality of sensors in said earth-based sensor network;
fixing said antennas in said aerostatic and fixed aerial locations, respectively, above said earth-based sensor network; and
maintaining said antennas in sufficiently stationary positions relative to a sensor in said earth-based sensor network to triangulate a location of said sensor on a surface of said earth from a locator signal received by said antennas from said sensor; and
wherein said said deploying said sensor comprises:
providing a deployer of said sensor with said sensor in proximity to an area of interest on said surface of said earth monitored by said earth-based sensor network;
receiving said locator signal from said sensor at said antennas of said plurality of aerostatic platforms;
triangulating a location of said sensor with respect to said surface of said earth;
measuring an offset of said location from a designated location in a deployment plan for sensors in said earth-based sensor network;
transmitting a deployment signal from at least one aerostatic platform of said plurality of aerostatic platforms to said deployer of said sensor if the offset of said location of said sensor from said designated location on said surface of said earth is less than a designated value; and
placing said sensor at said location in proximity to said designated location in response to said deployment signal.
